(19) United States
(12) Patent Application Publication
(10) Pub. No.: US 2003/0167232 A1
(43) Pub. Date: Sep. 4, 2003

(54) Method of reducing online fraud

(76) Inventor: Lascelles A. Linton, Potomac, MD (US)

Correspondence Address: DYKAS, SHAVER & NIPPER, LLP, P O BOX 877, BOISE, ID, 83701-0877, US

(21) Appl. No.: 10/090,207

(22) Filed: Mar. 1, 2002

(51) Int. Cl. G06F 17/60

(52) U.S. Cl. 705/44

(57) ABSTRACT

A method reducing commercial transaction fraud through utilizing a good faith money arrangement whereby at least one or both of the buyer and seller post good faith money payments to be donated to a charity or otherwise disposed of if the seller is not satisfied with the transaction.

### BACKGROUND OF THE INVENTION

The present invention generally relates to commercial transactions between buyers and sellers, and more particularly relates to a method of reducing the occurrence of fraud in online transactions, such as auctions.

Many individuals participate in online commercial transactions, for instance online auctions. Examples of such transactions are the auctions facilitated by the company known as eBay, Inc. In such an auction, a seller posts information about goods (or services) he/she wishes to sell on a website. This information is viewed by potential buyers who place bids on the seller's goods. Through this process, a winning bidder is determined. This winning bidder would then remit payment to the seller, who in turn would ship the goods to the winning bidder.

The National Fraud Information Center (http://www.fraud.org) estimated that 78% of the online fraud in 2000 was related to such Internet auctions. The possibilities for fraud in such a transaction are easily apparent. For instance, upon receiving the goods from the seller, the buyer could realize that they are not what the seller promised, for instance, a seller could offer an original work of art for sale, but ship a print. Another example might be where the buyer received the goods from the seller but then asks the seller for a refund, telling the seller that the goods were never delivered. Another example might be where the buyer only sends a partial payment or cancels the check mailed as payment. Another example might be where the seller ships the goods, but the buyer never pays.

To overcome some of these fraud risks, buyers and sellers infrequently utilize what is known as an “escrow service.” An escrow service serves as an intermediary in the transaction. A common form of escrow is one where the winning bidder would send his payment not to the seller, but to an escrow agent. This escrow agent would hold the payment in escrow. The seller would then receive notification from the escrow agent that payment had been tendered, at which time the seller would ship the goods to the buyer. Upon receipt of the goods, the buyer would notify the escrow agent to release the payment to the seller. Other renditions on this escrow theme are also possible. Escrow services are not frequently used because of their cost and their inconvenience.

Fraud can even arise through use of such an escrow service. For instance, a buyer could send his money to the escrow service, and the seller could then refuse to ship the goods to the buyer. In such a case, the buyer would be able to receive his money back from the escrow agent, however the buyer would be out the time, effort and headache of dealing with a transaction that fell through. Another example includes where the buyer receives the item but lies to the escrow agent, telling the escrow agent that the goods were never received, or that the wrong item was received and asks the escrow agent to send the buyer's payment back to the buyer. This type of escrow does not serve to prevent the buyer from committing fraud.

The reality is that the buyer (or seller) is left with limited options in resolving any problems which occur in the transaction. One option is the legal system, for instance, the first party could sue the second party in small claims court. Such an option is obviously not very practical when the two parties may live hundreds, if not thousands, of miles apart and the item in question may have a nominal value.

Another option provided by eBay and other auction providers has been the utilization of “feedback” wherein a defrauded or unsatisfied transaction participant can leave feedback regarding the transaction on a bulletin board for future potential buyers/sellers to review. In such a manner, if an auction participant defrauds another auction participant, hopefully a record will exist thereby warning future buyers/sellers of the offending individual's prior conduct.

What is needed is a method of doing business whereby a buyer's (or seller's) displeasure or frustration with the other party to the transaction can be at least partially satisfied. The present invention solves this need.

Note: while this disclosure discusses the particular application of the present invention to online auction services and transactions, such disclosure is not intended as a limitation. The present invention does and may have application in other transactions as well, the inclusion of which is intended in this application thorough this reference.

### SUMMARY OF THE INVENTION

The present invention is a method of reducing fraud in commercial transactions between a buyer and a seller for the purchase of goods (or services). In the preferred embodiment of the present invention, the buyer and seller agree on terms and conditions of the sale from the seller to buyer. These terms and conditions, for example, could include: the amount of the payment for the goods/services to be made by the buyer, the goods/services to be delivered by the seller to the buyer, the buyer and seller agreeing on a good faith money amount, the buyer and seller agreeing on a fourth party (charity), and the buyer and seller agreeing on a third party. The seller would then deposit the good faith money amount with the third party. The buyer would then transfer the amount of the payment with the third party. All of this deposited money (the good faith money and the payment) being held in trust by the third party.

After the seller antes up his/her good faith money amount to the third party, and the buyer antes up his/her payment amount for the goods to the third party, the seller would ship the goods to the buyer. The buyer would then receive the goods. If the buyer is satisfied with the goods, etc., the buyer would instruct the third party to transfer the entire deposited money to the seller. If the buyer is dissatisfied with the goods, the buyer would instruct the third party to transfer the entire deposited money to a charity (the fourth party).

Advantages of some of the potential embodiments of the present invention include not needing a review process (i.e., eBay “feedback”); the present invention is more automated (review, privacy, shipping fee, etc.) than the prior art methods, thereby making it cheaper than escrow to provide to consumers; interest from money held in trust could be used to lower fees for the invented method, or for paying for insurance, etc.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the description of the preferred embodiment is to be regarded as illustrative in nature, and not as restrictive.

### DESCRIPTION OF THE PREFERRED EMBODIMENTS

While the invention is susceptible of various modifications and alternative constructions, certain illustrated embodiments thereof will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The present invention is a method of reducing the likelihood of fraud occurring in a commercial transaction. The present invention makes fraud less attractive thereby reducing the likelihood that a person setting out to defraud someone would utilize a transaction using the invented method. One commercial transaction the present invention will work with is an online auction between a buyer and a seller.

In the preferred embodiment of the present invention, the seller offers for sale certain goods (or services, etc.) subject to certain terms and conditions. The buyer accepts the seller's offer and accepts the seller's terms and conditions. Alternatively, these terms and conditions could be set forth by the auction facilitating company, provided by the seller, negotiated by the seller and buyer, etc. The buyer and seller would then agree to, perhaps as part of the terms and conditions, the utilization of the invented method in order to reduce the chances of fraud taking place in the transaction.

Utilization of the preferred embodiment of the present invention requires, beyond the standard commercial transaction requirements (goods/services sold, payment price (“payment amount”) for the goods/services, shipping/handling, etc.), the buyer and seller to (1) determine that the seller will be putting up a good faith money amount, (2) determine the good faith money amount, (3) determine who will be holding the good faith money amount and the payment amount (the “deposited money”), (4) determine the conditions when the deposited money can be distributed, (5) determine to whom the deposited money will be distributed, and (6) determine how the deposited money will be distributed. Such determinations and agreements may be part of the auction itself, for instance, an option offered by an auction service provider. Other steps may be included in the present invention, and some of these steps may not be present in certain embodiments of the present invention. I will now explain these steps in more detail.

First, the buyer and seller (the “parties”) could agree that the seller will put up the good faith money amount and that the buyer would put up the payment amount. This description includes reference to what I call “good faith money.” Good faith money is money from the seller to show the buyer that the seller will incur some loss if the transaction is not completed successfully. In a less preferred embodiment, no good faith money amount will be put up by the seller and the steps of the invention will be adjusted accordingly.

Second, the good faith money amount must be agreed to by the buyer and seller. The good faith money amount may be a set dollar figure, a sliding-scale dollar figure dependent upon the price of the goods/service, a price equal to a percentage of the value of the goods (i.e., 10% the value), etc. This amount may be physically transferred, for instance by the payment of cash, check, credit card, etc. This amount may not be physically transferred, but may be done by giving the third party an assurance of payment or means of payment, for instance by giving the third party credit card information and authorization to charge the good faith money amount to the card. As part of the standard commercial transaction, the buyer and seller would also have agreed to the payment amount, the amount the buyer is going to pay the seller for the goods/services.

Third, the buyer and the seller will need to agree who will be holding the good faith money amount and payment amount. It is preferred that a neutral third party be utilized for this service. This third party could be the same individual utilized for escrow (if the parties utilize escrow). This third party could be the buyer or seller's financial institutions (i.e., PayPal). This third party could be the provider of auction services (i.e., eBay), or another person, business, organization, a computer, software, etc. Optionally, the third party who will hold the “good faith” money amount and payment amount could be determined by the escrow agent (if any), etc.

Fourth, the seller and buyer will need to agree when the good faith money amount and payment amount will be distributed. In the preferred embodiment, the deposited money amount is distributed when the buyer notifies the third party to do so. Another option, would be that the buyer and seller could agree that after a set period of time (for instance, a number of days after the buyer receives the goods) that the deposited money amount would be automatically released by the third party to the seller if the buyer does not otherwise indicate any problem with the transaction. The agreement between the buyer and seller could also provide some form of an extension to this deadline, for instance where there are shipping delays, etc.

Fifth, the parties need to agree whom the good faith money amount (and the payment amount) will be distributed. In the preferred embodiment, the good faith money amount (and the payment amount) could only be distributed to the seller or a fourth party, such as a charity, government, institution, entity, or any means of at least temporarily keeping the money away from the parties (buyer and seller), etc. (hereinafter “charity”). If a charity is selected the parties could possibly receive tax benefits from the donation. Of course, as throughout this application, the “third party” and this “fourth party” could be the same person (individual, organization, entity, business, etc.).

Another option would be to have the fourth party be some form of an arrangement whereby the good faith money amount and payment amount would be held in trust for the buyer and seller for a period of time. This would be sort of a good faith money amount penalty box. In such an arrangement, the seller's good faith money amount and the buyer's payment amount could, through triggering the application of the present invention, be held in trust for a period of time before it is released for distribution back to the buyer and seller (the seller's good faith money amount would be released back to the seller and the buyer's payment back to the buyer).

For instance, if the buyer was unhappy with the transaction, (for instance the goods shipped were damaged), the buyer could have the third party hold the deposited amount in trust (possibly, but not preferably, drawing interest) for a period of time. For instance, the money could be held for six (6) months, or a period of time where it might get one hundred percent of the value back (i.e., equal to the value of the item). Thus, by keeping the money (profits of the transaction) away from the parties for a period of time, fraud is less lucrative, thereby reducing the chances fraud will be an outcome.

In the preferred embodiment, the buyer and seller agree on terms and conditions of the sale from the seller to buyer. These terms and conditions, for example, could include: the amount of the payment for the goods to be made by the buyer, the goods/services to be delivered by the seller to the buyer, the buyer and seller agreeing on a good faith money amount, the buyer and seller agreeing on a fourth party (charity), and the buyer and seller agreeing on a third party. The seller would then deposit the good faith money amount with the third party. The buyer would then transfer the amount of the payment with the third party. All of this deposited money (the good faith money and the payment) being held in trust by the third party. After the seller antes up his/her good faith money amount to the third party, and the buyer antes up his/her payment amount for the goods to the third party, the seller would ship the goods to the buyer. The buyer would then receive the goods. If the buyer is satisfied with the goods, etc., the buyer would instruct the third party to transfer the entire deposited money to the seller. If the buyer is dissatisfied with the goods, the buyer would instruct the third party to transfer the entire deposited money to a charity (the fourth party).

In a second embodiment, the buyer and seller agree on terms and conditions of the sale from the seller to the buyer. These terms and conditions, for example, could include: the amount of the payment for the goods to be made by the buyer, the goods/services to be delivered by the seller to the buyer, the buyer and seller agreeing on a good faith money amount, the buyer and seller agreeing on a fourth party (charity), and the buyer and seller agreeing on a third party. The seller would then deposit the good faith money amount with the third party. The buyer would then transfer the amount of the payment with the third party. All of this deposited money (the good faith money and the payment) being held in trust by the third party. After the seller antes up his/her good faith money amount to the third party, and the buyer antes up his/her payment amount for the goods to the third party, the seller would ship the goods to the buyer. The buyer would then receive the goods. If the buyer is satisfied with the goods, etc., the buyer would instruct the third party to transfer the entire deposited money to the seller. If the buyer is dissatisfied with the goods, the buyer would instruct the third party to transfer the entire deposited money to a charity (the fourth party) that is supportive of the types of products being sold. This reduces the chances that a buyer would use such a transaction, via fraud, to reduce the circulation of items which the buyer disagrees with, for instance “banned” books. Determination of what supportive charity to transfer the deposited money to could be based upon the comments of one or both parties, randomly, based on statistical studies on trends, on the buyer's (and/or seller's) behavior, etc.

In a third embodiment, the buyer and seller agree on terms and conditions of the sale from the seller to the buyer. These terms and conditions, for example, could include: the amount of the payment for the goods to be made by the buyer, the goods/services to be delivered by the seller to the buyer, the buyer and seller agreeing on a good faith money amount, the buyer and seller agreeing on a fourth party (charity), and the buyer and seller agreeing on a third party. The seller would then deposit the good faith money amount with the third party. The buyer would then transfer the amount of the payment with the third party. All of this deposited money (the good faith money and the payment) being held in trust by the third party. After the seller antes up his/her good faith money amount to the third party, and the buyer antes up his/her payment amount for the goods to the third party, the seller would ship the goods to the buyer. The buyer would then receive the goods. If the buyer is satisfied with the goods, etc., the buyer would instruct the third party to transfer the entire deposited money to the seller. If the buyer is dissatisfied with the goods, the buyer would instruct the third party to transfer a certain portion of the entire deposited money to a charity (the fourth party). What portion would preferably be agreed to by the buyer and seller in advance. For instance, the seller could agree that if the item sold is not shipped timely that the fourth party would get $1.00 of the deposited money; the seller could agree that if the item sold is not of the quality described that the fourth party would get $2.00 of the deposited money, etc. Or, the portions could be options selected by the buyer. The record of these payments could also be linked to a more comprehensive review. Optionally, both parties (buyer and seller) could agree that a certain portion of the entire deposited money could be transferred to the buyer and seller or seller, buyer and the charity.

The buyer and seller may agree that utilization of the present invention is the sole remedy in case of a dispute over the transaction, should the parties so desire. This would eliminate the need for legal recourse, turning the present invention into an alternative method of resolving disputes. Alternatively, the seller and buyer could not disclose the occurrence of a sale to the third party.

Alternatively, the buyer and seller may agree to cancel the use of the invented method for the transaction in any manner chosen by the buyer and seller. In one example, the buyer and seller could cancel the transaction or the use of the invention, resulting in the payment returning to the buyer and the good faith money amount returning to the seller.

Information about buyers and sellers and the number of times they have transactions resulting in the good faith money being sent to a third party could also be tracked and displayed, if desired, as a replacement for, or enhancement to, traditional “feedback.”

While there is shown and described the present preferred embodiment of the invention, it is to be distinctly understood that this invention is not limited thereto but may be variously embodied to practice within the scope of the following claims.

I claim:

1. A method of reducing the occurrence of fraud in a commercial transaction between a seller selling goods and a buyer buying said goods, wherein said seller agrees to ship said goods to said buyer and said buyer agrees to remit a payment amount to said seller, said method comprising the steps of:
the buyer and seller agreeing on a good faith money amount;
the buyer and seller agreeing on a third party;
the buyer and seller agreeing on a fourth party;
the seller depositing an amount of money equal to said good faith money amount with said third party, said good faith money amount held in trust by said third party; and
the buyer depositing said payment amount with said third party;
wherein if said buyer indicates dissatisfaction with said commercial transaction, said third party tenders said good faith money amount and said payment amount to said fourth party;
wherein if said buyer indicates satisfaction with said commercial transaction, said third party tenders said good faith money amount and said payment amount to said seller.

2. The method of claim 1, wherein said fourth party is a charity.

3. The method of claim 2, wherein said charity is supportive of the type of goods comprising said goods.

4. The method of claim 1, wherein said seller and said buyer agree on said fourth party by agreeing to allow said third party to select said fourth party.

5. The method of claim 1, wherein said third party also provides escrow services to said buyer and said seller.

6. The method of claim 1, wherein said third party facilitates said commercial transaction for said buyer and said seller.

7. The method of claim 1, wherein if said buyer neither indicates satisfaction nor dissatisfaction with said commercial transaction, said fourth party holds said good faith money amount and said payment amount in trust for a predetermined amount of time before tendering said good faith money amount and said payment amount to said seller.

8. The method of claim 1, wherein said buyer and seller agree that utilization of the present invention is the sole legal remedy in case of a dispute over said commercial transaction.

9. A method of reducing the occurrence of fraud in a commercial transaction between a seller selling goods and a buyer buying said goods, wherein said seller agrees to ship said goods to said buyer and said buyer agrees to remit a payment amount to said seller, said method comprising the steps of:
the buyer and seller agreeing on a good faith money amount;
the buyer and seller agreeing on a third party;
the buyer and seller agreeing on a fourth party;
the seller depositing an amount of money equal to said good faith money amount with said third party, said good faith money amount held in trust by said third party; and
the buyer depositing said payment amount with said third party;
wherein if said buyer indicates dissatisfaction with a portion of said commercial transaction, said third party tenders a predetermined portion of said good faith money amount and said payment amount determined by said buyer to said fourth party and said third party tenders the remainder of said good faith money amount and said payment amount to said seller;
wherein if said buyer indicates satisfaction with said commercial transaction, said third party tenders said good faith money amount and said payment amount to said seller.

10. The method of claim 9, wherein said fourth party is a charity.

11. The method of claim 9, wherein said charity is supportive of the type of goods comprising said goods.

12. The method of claim 9, wherein if said buyer neither indicates satisfaction nor dissatisfaction with said commercial transaction, said fourth party holds said good faith money amount and said payment amount in trust for a predetermined amount of time before tendering said good faith money amount and said payment amount to said seller.

13. The method of claim 9, wherein said third party also provides escrow services to said buyer and said seller.

14. The method of claim 9, wherein said third party facilitates said commercial transaction for said buyer and said seller.

15. The method of claim 9, wherein said buyer and seller agree that utilization of the present invention is the sole legal remedy in case of a dispute over said commercial transaction.
